(19) United States
(12) Patent Application Publication
(10) Pub. No.: US 2012/0162523 A1
(43) Pub. Date: Jun. 28, 2012

(54) USING SCREEN CAPTURES TO PROVIDE AUTOMATIC CONTEXTUAL SMART INPUT-IN DEVICE SELECTION MENU

(75) Inventors: Paul R. Bastide, Boxford, MA (US); Lisa Seacat DeLuca, San Francisco, CA (US)

(73) Assignee: INTERNATIONAL BUSINESS MACHINES CORPORATION, Armonk, NY (US)

(21) Appl. No.: 13/411,587

(22) Filed: Mar. 4, 2012

Related U.S. Application Data
(63) Continuation of application No. 12/913,935, filed on Oct. 28, 2010.

(51) Int. Cl. H04N 5/50; H04N 5/44

(52) U.S. Cl. 348/569; 348/E05.097

(57) ABSTRACT

A two-way smart input-in device recognition mechanism determines which input slots of a multi-input display device (such as a television) are actually occupied, and obtains a screen capture of a graphic image for each such device. An embodiment of the present invention automatically associates the screen capture graphics with input-in device locations to enable presenting an intelligent visual input-in selection menu, which may be rendered in response to activation of a Menu button of a remote control device. Preferably, the input-in selection menu only displays graphics for currently-occupied input-in slots.

### BACKGROUND

The present invention relates to multi-input display devices (such as televisions), and deals more particularly with using screen captures of devices connected to the multi-input display device for rendering on an input selection menu for the multi-input display device.

Today, multiple devices may be attached to the so-called “input-in” slots of a television, and an input selection menu is used that enables toggling between the attached devices. Typically, the input selection menu is provided in response to a user pressing (or otherwise activating) a “Menu” button on a remote control device of the television, or perhaps a similar button on the television. An example screen 100 displaying an input selection menu might appear as illustrated in FIG. 1.

As can be seen by review of screen 100, the displayed choices are relatively generic in nature, and provide the user with minimal—and perhaps somewhat confusing—information. Screen 100 typically displays an entry for each available input-in slot, without regard to whether a device is currently plugged in to that slot. If a user connects a gaming device to the television, for example, the user will potentially have to rotate between all of the input selections on the menu 100 to find out where the gaming device is actually connected.

### BRIEF SUMMARY

The present invention is directed to providing an input selection menu for devices connected to a multi-input display device, such as a television. In one aspect, this comprises: obtaining, for at least one of a plurality of input slots of the multi-input display device, a screen capture of a graphic image representing a type of a device connected to the input slot; associating each obtained screen capture with the input slot to which the connected device is connected; and responsive to a request to display the input selection menu, rendering each associated screen capture. Obtaining the screen capture of the graphic image representing a type of the connected device may comprise capturing a graphic image rendered by the connected device upon a power-on of the connected device. Optionally, the obtained screen capture may be cropped, in which case the associating preferably associates the cropped screen capture with the input slot to which the connected device is connected and the rendering preferably renders the cropped screen capture.

Embodiments of these and other aspects of the present invention may be provided as methods, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

### BRIEF DESCRIPTION OF THE SEVERAL VIEWS OF THE DRAWINGS

The present invention will be described with reference to the following drawings, in which like reference numbers denote the same element throughout.

FIG. 1 illustrates an example of an input selection menu for a television, according to the prior art;

FIG. 2 provides a flowchart illustrating logic which may be used when implementing an embodiment of the present invention;

FIG. 3 illustrates a sample data structure which may be used for storing information used by an embodiment of the present invention;

FIG. 4 depicts a sample input selection menu, according to an embodiment of the present invention; and

FIG. 5 depicts a data processing system suitable for storing and/or executing program code.

### DETAILED DESCRIPTION

An embodiment of the present invention uses a two-way smart input-in device recognition mechanism to determine which input slots of a multi-input display device, such as a television, are actually occupied, and obtains a screen capture of a graphic image (also referred to herein as a screen capture, graphic image, or graphic) for each such device. An embodiment of the present invention automatically associates the screen capture graphics with input-in device locations to enable presenting an intelligent visual input-in selection menu (also referred to herein as an input selection menu). While embodiments of the present invention as described primarily with reference to a television herein, this is by way of illustration but not of limitation. As another example of a multi-input display device with which an embodiment of the present invention may be used, an interactive kiosk may be adapted for receiving input from multiple input-in slots. Accordingly, one or more embodiments of the present invention will now be discussed with reference to the term “television”, which should be construed as merely illustrative of a multi-input display device.

When devices that plug into a television are powered on, they typically display a welcome “splash” screen, which may include a logo or other descriptive information for the type of attached device. For example, gaming devices typically use a graphic representation of the specific type of gaming device, showing an image associated with the device brand. As another example, a TiVo® device renders an animated TiVo icon when the device powers on. An embodiment of the present invention captures such graphic images and visually presents the captured graphic to the user on the input selection menu. (“TiVo” is a registered trademark of TiVo Inc. in the United States, other countries, or both.)

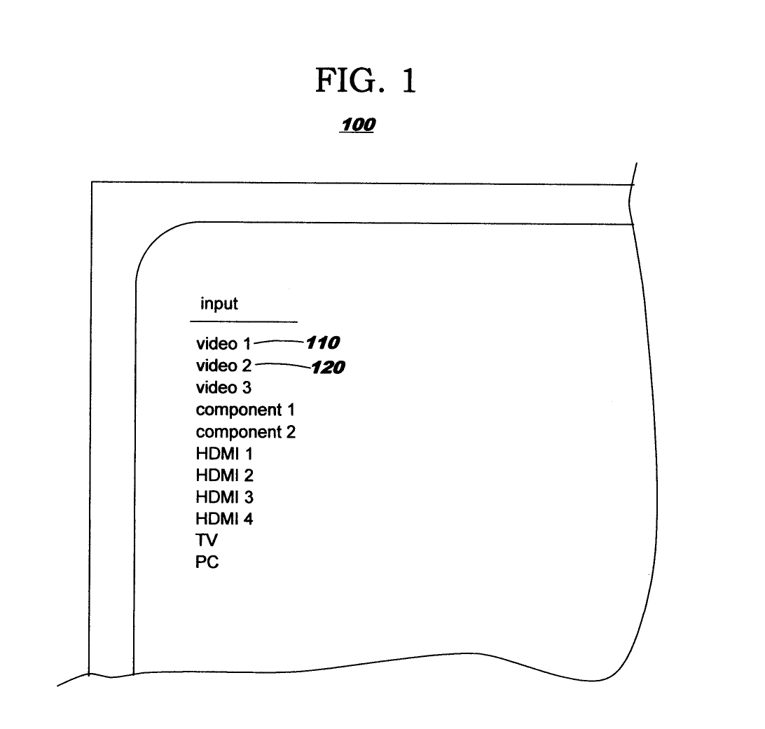

As noted above with reference to screen 100 of FIG. 1, a television of the prior art typically shows an input selection menu with an entry for all potential input-in slots, with a textual description of each slot, and the textual description typically provides only generic information. By contrast, an embodiment of the present invention displays an input selection menu that associates screen capture graphics with each plugged-in input device. For example, rather than displaying “video 1” and “video 2” as shown at 110, 120 of FIG. 1, an embodiment of the present invention detects whether devices are currently plugged in to the video-1 and video-2 input slots and if so, the displayed input selection menu provides a screen capture of a graphic associated with that particular type of input device. Accordingly, this input selection menu may be termed an “intelligent” menu.

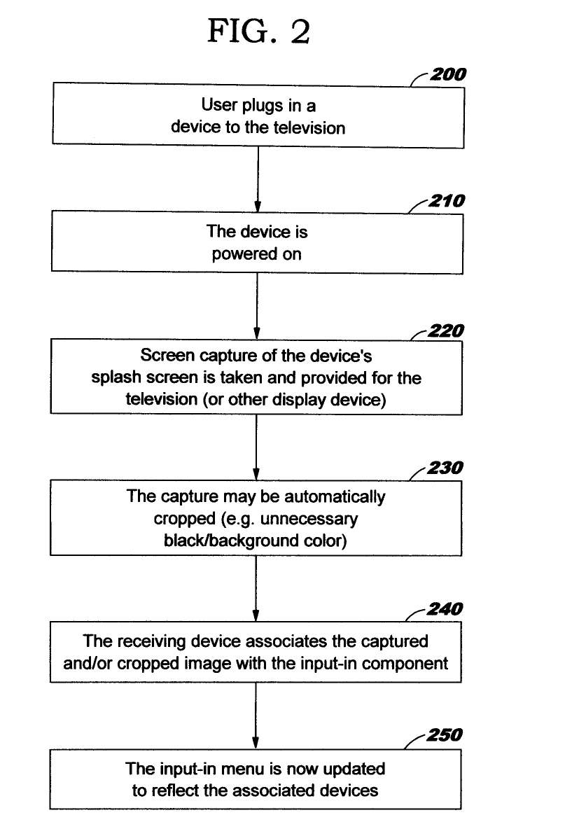

FIG. 2 provides a flowchart illustrating logic which may be used when implementing an embodiment of the present invention. As shown therein, in one aspect, a user plugs a device into the television (Block 200). As the plugged-in device is powered on (Block 210), it renders a graphic image. A screen capture is taken of the rendered graphic image (Block 220) and this screen capture is made available for the television (or other display device).

The screen capture may be automatically cropped (Block 230). As one example of when cropping may be performed, the screen capture may include gray or black borders on the left and right sides. This may happen, for example, if the television provides high-definition pictures but the plugged-in device does not. In this case, the cropping at Block 230 preferably comprises removing these borders. More generally, the cropping may be performed upon detecting that the screen capture includes an image fill pattern. As another example of when cropping may be performed, if the input device provides a splash screen of a certain dimension, but the television uses a different aspect ratio between the horizontal and vertical picture size, then the cropping at Block 230 preferably comprises resizing the captured splash screen to match the aspect ratio of the television.

In some cases, cropping may not be required, and the processing of Block 230 may be omitted in such cases.

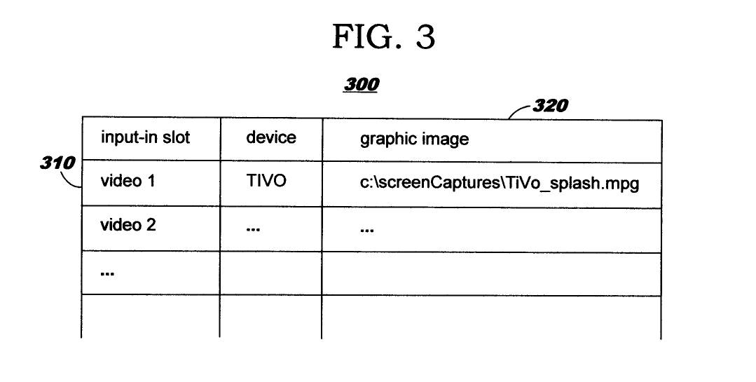

The screen capture obtained at Block 220 may be stored in persistent storage (Block 240), in association with an identification of the plugged-in device and its input-in slot, as illustrated by table 300 in FIG. 3. For example, if a TiVo device is plugged in to the video-1 input slot, the splash screen rendered by that TiVo device may be stored in a file named

c:\screenCaptures\TiVo_splash.mpg

as shown in row 310 of table 300. As will be obvious to one of ordinary skill in the art, table 300 is merely illustrative of a data structure that may be used for storing information according to an embodiment of the present invention.

When cropping is performed at Block 230, the processing at Block 240 preferably stores the cropped image in persistent storage, in association with the identification of the plugged-in device and its input-in slot. This may comprise writing the file name of the cropped image in column 320 of table 300. As an alternative, an additional column may be used (not shown in FIG. 3) in order to record the name of the file in which the cropped image is stored in addition to recording the file name of the original (i.e., pre-cropped) image in column 320.

Referring again to FIG. 2, the input selection menu is updated (Block 250) to reflect the devices in the currently-occupied slots and the screen capture (which may have been cropped) that will be rendered by an embodiment of the present invention to represent each plugged-in device. The rendering may comprise displaying a still image, an animation, a short movie, etc. The processing of this iteration of the logic in FIG. 2 then ends.

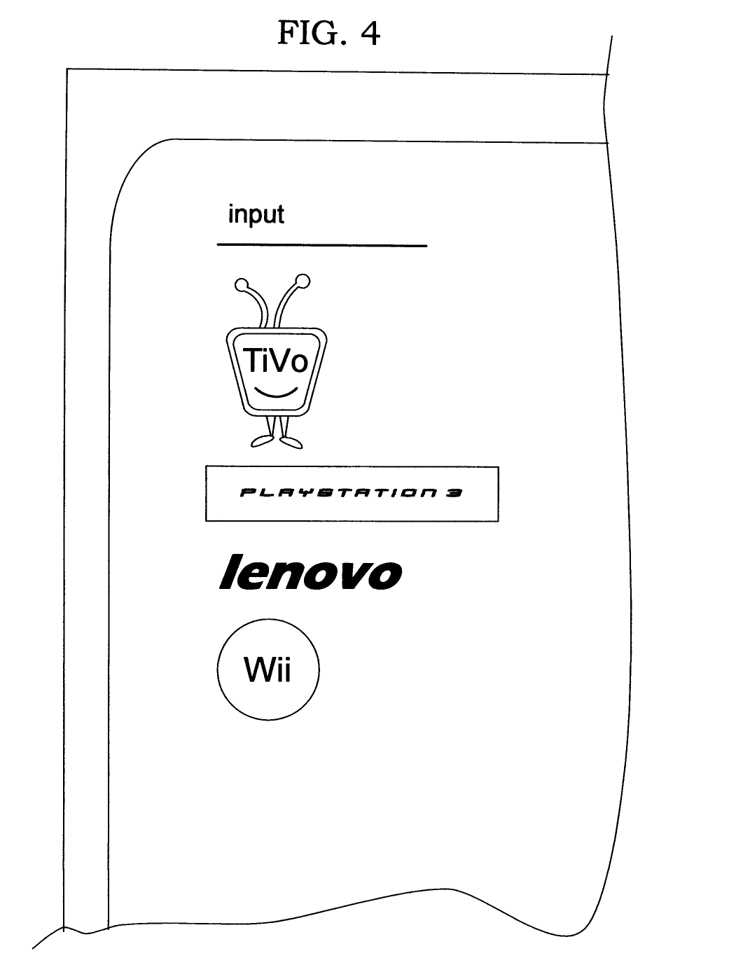

FIG. 4 provides an illustration of an input selection menu that may be rendered when the input-in slots are occupied by a TiVo device, a PlayStation® gaming device, a Lenovo® personal computer, and a Wii® gaming device. As will be obvious to one of ordinary skill in the art, FIG. 4 is merely illustrative. Note that the graphics representing the plugged-in devices are not required to be rendered in a vertical alignment as shown in FIG. 4, and alternative alignments are within the scope of the present invention. (“PlayStation” is a registered trademark of Sony Computer Entertainment Inc. in the United States, other countries, or both. Lenovo® is a registered trademark of Lenovo in the United States, other countries, or both. Wii® is a registered trademark of Nintendo in the United States, other countries, or both.)

In one aspect, once an image has been stored for a particular input device, that image may be persisted (as discussed above with reference to table 300 of FIG. 3) and reused when the device and/or the television is subsequently powered on. Preferably, the television rechecks the occupied slots at each power on. In another aspect, the graphic image for a plugged-in device is recaptured (and optionally re-cropped) each time the device is powered on. This may comprise performing another iteration of the logic illustrated in Blocks 210-250 of FIG. 2.

In particular, if the television is turned off when a device is plugged in, then the screen capture for the device is preferably captured and provided to the television at power-on of the television in one aspect. In another aspect, the device itself may capture its splash screen image at power-on of the device, and subsequently forward this captured image to the television when the television powers on. If a plugged-in device itself is not powered on when the television powers on, then in one aspect, the screen capture for that device is not displayed on the input selection menu until the plugged-in device powers on. In another aspect, a previously-stored graphic associated with that device and that input-in slot may be rendered on the input selection menu. For example, a data structure such as table 300 of FIG. 3 may be consulted to determine which graphic image (see column 320) to display.

An input selection menu (such as menu 400 of FIG. 4) is preferably displayed in response to pressing or otherwise activating a Menu button of a remote control device. As one alternative, the input selection menu may be displayed in response to pressing or otherwise activating a Menu button of the television itself. Navigation among the displayed graphic images preferably occurs using known techniques, such as by pressing or otherwise activating up and down arrow buttons on the remote control device. Selection of a choice rendered on the input selection menu also preferably occurs using known techniques, such as pressing or otherwise activating a “Select” button of the remote control device.

Discussions provided above refer to a device as having a single associated graphic image. It may happen, however, that more than one graphic image is associated with a particular device or devices. In that case, the processing of FIG. 2 may be adapted to capture and process each of the associated images. The data structure illustrated in FIG. 3 may also be adapted for persisting information about additional images (for example, by using a list of file names in column 320).

Optionally, an embodiment of the present invention may be adapted for accessibility. For example, it may happen that the graphic images are relatively small, which may make them difficult to view by a sight-impaired person. Accordingly, an accessibility feature may be provided, and this accessibility feature may comprise (by way of example, but not of limitation) adapting at least one of a size, a color, and a font of at least one of the graphic images.

It may happen that a plugged-in device has a sound associated with the device type. For example, a TiVo device commonly emits a distinctive sound upon start-up of the device. Accordingly, an embodiment of the present invention may optionally capture such sound, and then persist and render the sound in addition to the image(s) that were captured. It will be obvious to one of ordinary skill in the art, given the disclosure provided herein, how the logic of FIG. 2 may be adapted to add handling of sounds. A column may be added to the data structure shown in FIG. 3 to persist a file name at which the captured sound is stored.

As yet another option, an embodiment of the present invention may be adapted for sharing captured graphic images with other devices. As one example, a TiVo device may wirelessly transmit its screen capture, and this wireless transmission may be received by other devices in addition to the capture that occurs through the input-in slot. (The wireless transmission may use known technology, such as Bluetooth®, infrared, etc.) As another example, the screen capture may be obtained using the input-in slot, and this captured image may then be transmitted wirelessly to other devices. A Logitech Harmony® remote control device, for example, might receive a transmission of a captured image. Smart phones are another example of devices that might receive a transmission of a captured image. When an image is shared with (i.e., received by) other devices, the image may be rendered on the television and on one or more other devices. The Logitech Harmony remote control device, for example, includes a display area, and images captured according to an embodiment of the present invention may be rendered in this display area. If sound is emitted by a plugged-in device and captured as discussed above, this sound may also be received at other devices through wireless technology, and the sound may be rendered with such devices in addition to (or instead of) the image. (“Bluetooth” is a registered trademark of Bluetooth SIG, Inc., in the United States, other countries, or both. “Harmony” is a registered trademark of Logitech in the United States, other countries, or both.)

A television adapted for an embodiment of the present invention may be considered a two-way input device, in that it knows when a slot is occupied and therefore knows when a screen capture is needed for the plugged-in device. And as noted earlier, while preferred embodiments are discussed herein with reference to a television, the disclosed techniques may also be used with other multi-input display devices without deviating from the scope of the present invention.

Optionally, a special graphic image may be rendered in association with each available input-in slot that is currently empty, although this has not been illustrated in FIG. 4. As one example, a graphic of the word “empty” may be rendered for each unoccupied slot.

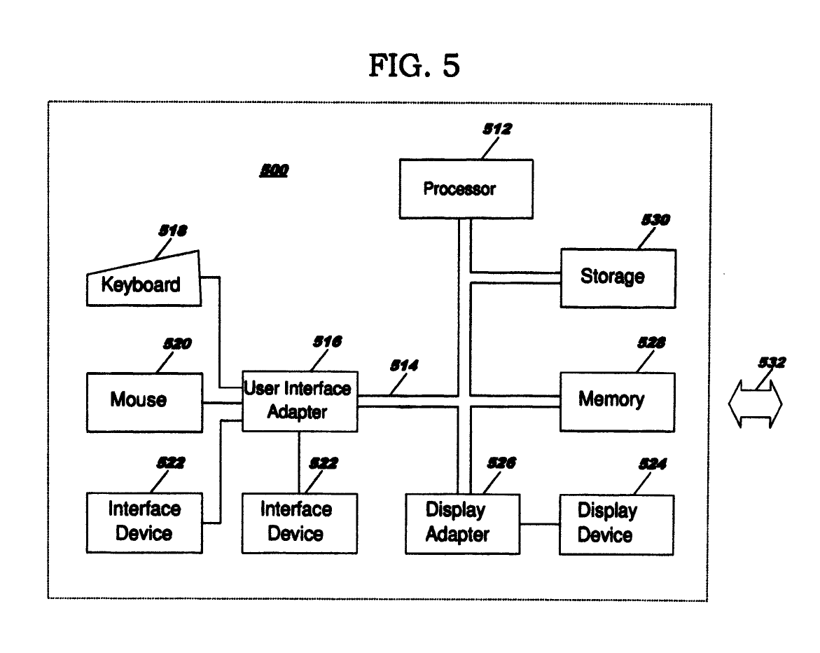

Program code for carrying out an embodiment of the present invention may be embodied in a computing device or data processing system, and this computing device or data processing system may be embodied in or otherwise accessible to a television or other multi-input display device. Referring now to FIG. 5, a data processing system 500 suitable for storing and/or executing program code includes at least one processor 512 coupled directly or indirectly to memory elements through a system bus 514. The memory elements can include local memory 528 employed during actual execution of the program code, bulk storage 530, and cache memories (not shown) which provide temporary storage of at least some program code in order to reduce the number of times code must be retrieved from bulk storage during execution.

Input/output (“I/O”) devices (including but not limited to keyboards 518, displays 524, pointing devices 520, other interface devices 522, etc.) can be coupled to the system either directly or through intervening I/O controllers or adapters (516, 526).

Network adapters may also be coupled to the system to enable the data processing system to become coupled to other data processing systems or remote printers or storage devices through intervening private or public networks (as shown generally at 532). Modems, cable modem attachments, wireless adapters, and Ethernet cards are just a few of the currently-available types of network adapters.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit”, “module”, or “system”. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (“RAM”), a read-only memory (“ROM”), an erasable programmable read-only memory (“EPROM” or flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radio frequency, etc., or any suitable combination of the foregoing.

Computer program code for carrying out operations for aspects of the present invention may be written in any combination of one or more programming languages, including an object oriented programming language such as Java, Smalltalk, C++, or the like, and conventional procedural programming languages such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computing device through any type of network, including a local area network (“LAN”) or a wide area network (“WAN”), or the connection may be made to an external computer (for example, through the Internet using an Internet Service Provider).

Aspects of the present invention are described above with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

Flowcharts and block diagrams in the figures herein illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or each flowchart illustration, and combinations of blocks in the block diagrams and/or flowchart illustration, can be implemented by special purpose hardware-based systems that perform the specified functions or acts, or combinations of special purpose hardware and computer instructions.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of providing an input selection menu for devices connected to a multi-input display device, comprising:
obtaining, for at least one of a plurality of input slots of the multi-input display device a screen capture of a graphic image representing a type of a device connected to the input slot;
associating each obtained screen capture with the input slot to which the connected device is connected; and
responsive to a request to display the input selection menu, rendering each associated screen capture.

2. The method according to claim 1, wherein obtaining a screen capture of a graphic image comprises capturing a graphic image rendered by the connected device upon a power-on of the connected device.

3. The method according to claim 1, further comprising:
cropping the obtained screen capture; and
wherein:
the associating associates the cropped screen capture with the input slot to which the connected device is connected; and
the rendering renders the cropped screen capture.

4. The method according to claim 3, wherein the cropping is performed responsive to determining that the obtained screen capture does not match an aspect ratio used by the multi-input display device.

5. The method according to claim 3, wherein the cropping is performed responsive to determining that the obtained screen capture contains an image fill pattern.

6. The method according to claim 1, wherein the multi-input display device is a television and the request to display the input selection menu is received with a remote control device operable with the television.

7. The method according to claim 1, wherein the request to display the input selection menu is received with an input mechanism of the multi-input display device.

8. The method according to claim 1, wherein the obtaining is performed responsive to a power-on of the multi-input display device.

9. The method according to claim 1, wherein the obtaining is performed responsive to a power-on of the connected device.
